(19) United States
(12) Patent Application Publication
(10) Pub. No.: US 2021/0019657 A1
(43) Pub. Date: Jan. 21, 2021

(54) FRAUD DETECTION AND RISK ASSESSMENT METHOD, SYSTEM, DEVICE, AND STORAGE MEDIUM

(71) Applicant: WELAB INFORMATION TECHNOLOGY (SHENZHEN) LIMITED, Shenzhen (CN)

(72) Inventors: HuanMing Wu, Shenzhen (CN); Chao Lan, Shenzhen (CN); FaYuan Li, Shenzhen (CN); QinYa He, Shenzhen (CN)

(21) Appl. No.: 17/040,505

(22) PCT Filed: Apr. 25, 2018
(86) PCT No.: PCT/CN2018/084405

§ 371 Date: Sep. 22, 2020

(30) Foreign Application Priority Data
Mar. 23, 2018 (CN) 201810245673.1

(51) Int. Cl. G06N 20/00; G06N 5/00; G06K 9/62; G06F 8/71; H04L 29/08; G06Q 10/06

(52) U.S. Cl. CPC G06N 20/00; G06N 5/003; G06K 9/6256; G06Q 10/0635; G06F 8/71; H04L 67/34; G06K 9/6215

(57) ABSTRACT

The present application provides a fraud detection and risk assessment method, a system, a device, and a computer readable storage medium. Said method comprises the following steps: acquiring original data of a client user; using a data processing algorithm to extract characteristic data from the original data; inputting the characteristic data into a pre-trained machine learning model matching the characteristic data, generating a model output result, and uploading same onto a server; and outputting a fraud detection and risk assessment result using a risk control decision engine in conjunction with the model output result, historical data associated with the client user, and third party data. By using the present application, the computing capability of a client device can be fully utilized, reducing the computing pressure on the server. As the client does not need to upload the original data to the server, the present application can also reduce the data transmission pressure on the client and the server and reduce the risk of leakage of the user's private data and security information.

### DECLARATION OF PRIORITY

The present application claims the priority of Chinese patent application no. 201810245673.1 with invention title “Fraud detection and risk assessment method, system, device and storage medium” submitted to the Chinese Patent Office on Mar. 23, 2017, the entire contents of which are incorporated herein by reference.

### TECHNICAL FIELD

The present application relates to the technical field of information processing, in particular to a fraud detection and risk assessment method, system, device and storage medium.

### BACKGROUND ART

Conventional big data applications rely on cloud computing, i.e. data is collected at a client and then uploaded to a centralized cloud server, big data technology is used to perform machine learning to obtain a model or form an intelligent inference, and fraud detection and risk assessment are thereby performed, e.g. to solve the special anti-fraud and risk assessment problems in the internet financial field. However, such technology has some problems which are difficult to solve at present:

1. The cloud server needs to process vast amounts of data generated by the client, and this will give rise to very high transmission and computing costs.

2. Limited by network bandwidth and delays, the technology is not suitable for real-time applications with high user experience requirements.

3. Personal privacy and data security are being taken more and more seriously, and most client big data involves personal privacy to a high degree; no matter whether we are talking about users' personal awareness or associated information protection policies, the collection, transmission and storage of such private data by third parties will be avoided as far as possible.

Furthermore, as smart terminal technology develops, the computing ability of client devices is increasing rapidly; dedicated AI chips are even starting to be integrated in these, examples being the Apple All chip and the Huawei Kirin 970 chip, both of which integrate a processing unit specifically for AI on an SoC (CPU/GPU/ISP/DSP) (an embedded neural network processing unit, NPU, is added), and this provides very good conditions for edge computing, making it possible to meet users' demands in terms of real-time services and security/privacy protection.

### SUMMARY OF THE INVENTION

In view of the above reasons, there is a need to provide a fraud detection and risk assessment method, system, device and storage medium, which can: use the computing ability of a client device to migrate certain algorithms and models, which are conventionally deployed in a server and associated with the client and client user data, to the client; compute a preliminary assessment result and then transmit this to the server as a risk factor; and then use a risk control decision engine of the server and other known associated data to obtain a final fraud detection and risk assessment result.

To achieve the abovementioned object, the present application provides a fraud detection and risk assessment method, applied to a client, the method comprising:

a data collection step: collecting original data of a client user, the original data comprising user material, communication data and behaviour data;

a data processing step: using a data processing algorithm to extract characteristic data from the original data, the characteristic data comprising user behaviour characteristic data, interest/hobby characteristic data and activity range characteristic data;

a model application step: inputting the characteristic data into a machine learning model, which is obtained by pre-training and matched to the characteristic data, to generate a model output result, and uploading same to a server; and

a receiving step: receiving a fraud detection and risk assessment result fed back by the server, said result being output by a risk control decision engine according to the model output result and historical data and third party data associated with the client user.

The present application further provides another fraud detection and risk assessment method, applied to a server, the method comprising:

a setting step: setting a data processing algorithm and machine learning model associated with fraud detection and risk assessment;

a distributing step: distributing the data processing algorithm and machine learning model to an associated client;

a receiving step: receiving a model output result, generated by the client using original data of a client user and the data processing algorithm and machine learning model;

an output step: using a risk control decision engine, combining the model output result and historical data and third party data associated with the client user, and outputting a fraud detection and risk assessment result.

The present application further provides a fraud detection and risk assessment system, comprising a server and at least one client, the client comprising:

a data collection module, configured to collect original data of a client user, the original data comprising user material, communication data and behaviour data;

a data processing module, configured to use a data processing algorithm to extract characteristic data from the original data, the characteristic data comprising user behaviour characteristic data, interest/hobby characteristic data and activity range characteristic data;

a model application module, configured to input the characteristic data into a machine learning model, which is obtained by pre-training and matched to a type of the characteristic data, to generate a model output result, and upload same to a server;

a first model training module, configured to use local characteristic data of the client to train the machine learning model at the client, and store the machine learning model obtained by training in a local model library of the client;

an algorithm and model management module, configured to match and update the data processing algorithm and machine learning model;

the server comprising:

a second model training module, configured to collect and use characteristic data of each client, to train the machine learning model, and store the machine learning model obtained by training in a model library of the server;

a management and distribution module, configured to set, match and update the data processing algorithm and machine learning model associated with fraud detection and risk assessment, and provide to the client the service of distributing the data processing algorithm and machine learning model;

a risk control decision engine module, configured to receive the model output result uploaded by the client, combine this with historical data and third party data associated with the client user, and output a fraud detection and risk assessment result;

a service management module, configured to activate the fraud detection and risk assessment system in response to a service request of the client.

The present application further provides a client device, which stores a fraud detection and risk assessment client program; the client device, when executing the fraud detection and risk assessment client program, realizes the following steps:

a data collection step: collecting original data of a client user, the original data comprising user material, communication data and behaviour data;

a data processing step: using a data processing algorithm to extract characteristic data from the original data, the characteristic data comprising user behaviour characteristic data, interest/hobby characteristic data and activity range characteristic data;

a model application step: inputting the characteristic data into a machine learning model, which is obtained by pre-training and matched to the characteristic data, to generate a model output result, and uploading same to a server; and

a receiving step: receiving a fraud detection and risk assessment result fed back by the server, said result being output by a risk control decision engine according to the model output result and historical data and third party data associated with the client user.

Correspondingly, the present application further provides a server, which stores a fraud detection and risk assessment server program; the server, when executing the fraud detection and risk assessment server program, realizes the following steps:

a setting step: setting a data processing algorithm and machine learning model associated with fraud detection and risk assessment;

a distributing step: distributing the data processing algorithm and machine learning model to an associated client;

a receiving step: receiving a model output result, generated by the client using original data of a client user and the data processing algorithm and machine learning model;

an output step: using a risk control decision engine, combining the model output result and historical data and third party data associated with the client user, and outputting a fraud detection and risk assessment result.

The present application further provides a computer-readable storage medium, comprising a fraud detection and risk assessment client program which, when executed, realizes the following steps:

a data collection step: collecting original data of a client user, the original data comprising user material, communication data and behaviour data;

a data processing step: using a data processing algorithm to extract characteristic data from the original data, the characteristic data comprising user behaviour characteristic data, interest/hobby characteristic data and activity range characteristic data;

a model application step: inputting the characteristic data into a machine learning model, which is obtained by pre-training and matched to the characteristic data, to generate a model output result, and uploading same to a server; and

a receiving step: receiving a fraud detection and risk assessment result fed back by the server, said result being output by a risk control decision engine according to the model output result and historical data and third party data associated with the client user.

The present application further provides another computer-readable storage medium, comprising a fraud detection and risk assessment server program which, when executed, realizes the following steps:

a setting step: setting a data processing algorithm and machine learning model associated with fraud detection and risk assessment;

a distributing step: distributing the data processing algorithm and machine learning model to an associated client;

a receiving step: receiving a model output result, generated by the client using original data of a client user and the data processing algorithm and machine learning model;

an output step: using a risk control decision engine, combining the model output result and historical data and third party data associated with the client user, and outputting a fraud detection and risk assessment result.

In the fraud detection and risk assessment method, system, device and storage medium provided in the present application, certain data processing algorithms and machine learning models which are conventionally deployed on a server are distributed to a client, thus local original data of the client is used to calculate a model output result, which is then uploaded to the server as a risk factor, and a risk control decision engine of the server outputs a fraud detection and risk assessment result according to the model output result and historical data and third party data associated with the client user. Using the present application, the client need not upload original data to the server, so it is possible to protect the user's personal privacy and reduce data transmission pressure between the client and the server; by using the computing ability of the client device, computing pressure at the server can be reduced, and the user experience of real-time applications can be improved.

### BRIEF DESCRIPTION OF THE DRAWINGS

FIG. 1 is a system architecture diagram of a preferred embodiment of the fraud detection and risk assessment system of the present application.

FIG. 2 is a schematic diagram of an embodiment of the risk control decision engine module in FIG. 1.

FIG. 3 is a program module diagram of a preferred embodiment of the fraud detection and risk assessment client program of the present application.

FIG. 4 is a program module diagram of a preferred embodiment of the fraud detection and risk assessment server program of the present application.

FIG. 5 is a flow chart of a first preferred embodiment of the fraud detection and risk assessment method of the present application.

FIG. 6 is a flow chart of a second preferred embodiment of the fraud detection and risk assessment method of the present application.

FIG. 7 is a flow chart of a preferred embodiment of the process of training the machine learning model of the present application.

FIG. 8 is a flow chart of a preferred embodiment of the process of updating the data processing algorithm and machine learning model of the present application.

The realization of the object of the present application, the functional characteristics and advantages thereof will be further explained with reference to the drawings in conjunction with embodiments.

### DETAILED DESCRIPTION OF THE INVENTION

To clarify the object, technical solution and advantages of the present application, the present application is explained in further detail below in conjunction with a number of drawings and embodiments. It should be understood that the specific embodiments described here are merely intended to explain the present application, not to limit it. All other embodiments obtained by those skilled in the art on the basis of the embodiments herein without creative effort shall fall within the scope of protection of the present application.

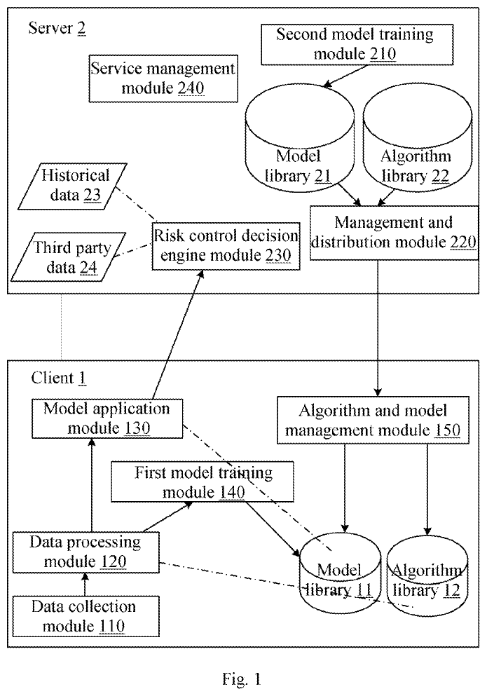

Referring to FIG. 1, this is a system architecture diagram of a preferred embodiment of the fraud detection and risk assessment system of the present application. In this embodiment, the fraud detection and risk assessment system comprises a server 2 and at least one client 1, wherein the client 1 may be a terminal device having storage and arithmetical operation functions such as a smartphone, a tablet computer, a portable computer or a tabletop computer, and the server 2 is a cloud server; the server and the client are connected via a network.

The client 1 mainly comprises a data collection module 110, a data processing module 120, a model application module 130, a first model training module 140, and an algorithm and model management module 150; the server 2 mainly comprises a second model training module 210, a management and distribution module 220, a risk control decision engine module 230 and a service management module 240. The modules referred to herein are a series of computer program instruction segments capable of performing specific functions. In addition to the modules mentioned above, the client 1 further comprises an algorithm library 11 for storing data processing algorithms, and a model library 12 for storing machine learning models obtained by training; and the server 2 also comprises an algorithm library 21 for storing data processing algorithms, and a model library 22 for storing machine learning models obtained by training. As can be understood, the client 1 and the server 2 further comprise databases for storing data information, etc., wherein the client database stores original data of a client user, and the server database stores third party data 24 and historical data 23 of each client user.

FIG. 1 only shows some of the modules and components of the fraud detection and risk assessment system of the present application, but it should be understood that it is not a requirement that all of the modules or components shown be implemented; alternatively, a greater or smaller number of modules or components may be implemented. For example, the fraud detection and risk assessment system may also a number of third party data interfaces, etc., which are not described further here.

The data collection module 110 is configured to collect original data of the client user, including user material, communication data and behaviour data. For example, the user material comprises software/hardware parameters of a client device (e.g. physical sensor data), network parameters (e.g. network type) and personal material of the user, e.g. a user photograph and video acquired from user-installed software, etc. The communication data comprises a contact list, call data and SMS data of the user, etc. The behaviour data comprises data such as the user's APP usage behaviour and webpage browsing behaviour, user position recorded by GPS, etc. These original data are only used at the client, and will not be uploaded to the server, in order to reduce data transmission costs and the risk of disclosure of the user's private data and secure information.

The data processing module 120 is configured to subject the original data of the client user to preliminary processing using a data processing algorithm, in order to extract characteristic data of the client user, including user behaviour characteristic data, interest/hobby characteristic data and activity range characteristic data. As can be understood, when the original data is subjected to preliminary processing, mutually intersecting characteristic data might be generated. For example, user activity range characteristic data (activity range of the user's work, life, etc.) may be extracted from user position data recorded by GPS, and information such as the user's age group, identity class (e.g. student, teacher, legal worker), economic status and air travel characteristics might also be inferred.

The data processing algorithm comprises a natural language processing algorithm, an image identification algorithm, etc.

By using a natural language processing algorithm to process contact list data, it is possible to extract communication behaviour characteristic data such as the total number of contacts, the number of contacts who are relatives, the number of close contacts, the number of local contacts, the number of contacts in other places, and the number of contacts added recently. Similarly, communication behaviour characteristic data such as call time points, call duration, call frequency and the other party to the call can be extracted from call record data. Furthermore, characteristic data such as the user's income level, shopping preferences and adverse credit history can be extracted from SMS messages (e.g. payment reminders, fee payment reminders, repayment reminders, arrears reminders) received by the user from various merchants (e.g. providers of goods/services such as online shopping platforms and banks).

By using an image identification algorithm to process user photographs and videos, it is possible to extract characteristic data such as the place of capture, the object of capture (the person or thing appearing in the photograph), capture preferences (portrait, scenery, food, etc.), and use this to assist in determining the occupation or even the age group of the user.

In addition, interest/hobby characteristic data of the user can also be extracted by analysing and processing behaviour data of the user such as APP installation and usage and webpage browsing.

The above description of the extraction of characteristic data from the original data by the data processing module 120 only provides some examples, and is not exhaustive.

The model application module 130 is configured to input the characteristic data into a machine learning model, which is obtained by pre-training and matched to the type of the characteristic data, generate a model output result, and upload same to the server. The machine learning model obtained by pre-training may be stored by the client in the client's local model library after pre-training, or distributed to the client by the server after pre-training. Models of the following types are generally included: natural language processing models, image identification models, fraud detection models, income characteristic models, social interaction characteristic models, payment ability characteristic models, debt repayment ability characteristic models, compliance tendency characteristic models, online shopping characteristic models, etc.

For example, an income characteristic model is distributed to the client by the server after pre-training. The income characteristic model may be obtained by training on the basis of a vast amount of user income characteristic data. The income characteristic data used in the training process includes device model numbers and device prices of various clients, the number of installations and frequency of use of various types of APP, natural language processing results relating to income information (bank transfer completion data such as salary, bonuses, investment and finance) in SMS content, browsing frequency of various types of website, average property price of work/home address, photograph and video identification results, etc. The income characteristic data may be sourced from historical data and third party data, including income characteristic data uploaded by the client user. The server uses these income characteristic data to train a machine learning model offline in an integrated manner, e.g. a gradient boosting decision tree (GBDT), to obtain the income characteristic model, which it stores in the server model library 21 and distributes to the client. After receiving the income characteristic model, the client can input the income characteristic data extracted by the data processing module 120 into the model, and assess the income level of the client user; the model output result generated is an income assessment value of the client user.

As another example, a fraud detection model can detect abnormal behaviour of deliberate fraud such as falsified material and stolen identity of the client user; this model may also be distributed to the client by the server after pre-training. Fraud characteristic data used in the training process includes behaviour characteristic data such as the user's text input speed when using an APP, the frequency of amendments, whether input is interrupted, whether the APP switches to background running when input is interrupted, the time interval when inputting different fields, and data collected by movement sensors (accelerometer/gyroscope, etc.) when information is inputted. Fraud characteristic data of a vast number of normal users is used to train a machine learning model, e.g. a deep neural network model or random forest model; the fraud detection model so obtained can detect differences in behaviour mode between a normal user and a user suspected of being fraudulent. After the server has distributed the fraud detection model obtained by training to the client, the client can compute a degree of difference between current user behaviour and normal user behaviour according to real-time behaviour characteristic data of a user when using the APP, and then determine a fraud probability for the current user. A similar fraud detection model may also be obtained by training at the client, and used to detect abnormal behaviour of the client user that is different from a behaviour mode when the APP is usually used. The fraud detection model trained at the client, in addition to using the abovementioned behaviour characteristic data, also uses fraud characteristic data which includes the network that is connected when the APP is used, and the time and place of use, etc. When the client user uses an unfamiliar network at an abnormal time in an abnormal place to initiate some important service requests, the fraud detection model obtained by training at the client can detect abnormal behaviour of the user, and further guide the user to perform identity verification, thereby avoiding economic loss for the user.

The first model training module 140 is configured to train a machine learning model at the client using local characteristic data of the client, and store a machine learning model obtained by training in the local model library of the client. The first model training module 140 generally uses characteristic data such as time sequence data to train a personalized machine learning model for each client user; reference may be made to the above description of the training of a fraud detection model at the client end in the model application module 130, and no further description is given here.

The algorithm and model management module 150 is configured to match and update the data processing algorithm and machine learning model. When the client user initiates a service request of some kind, the fraud detection and risk assessment system is activated, and the algorithm and model management module 150 will automatically match corresponding data processing algorithms and machine learning models for use by the data processing module 120 and the model application module 130. For example, when the client user initiates an online loan application on an internet finance platform, the algorithm and model management module 150 will automatically match an algorithm for natural language processing, etc. for use by the data processing module 120, such that the latter extracts characteristic data of the user such as income level and adverse credit history from the original data collected by the data collection module 110, and will automatically match a fraud detection model, a compliance tendency characteristic model and a debt repayment ability characteristic model, etc. for use by the model application module 130, such that the latter generates a model output result of each model according to the characteristic data of the user such as income level and adverse credit history.

The process of matching and updating the data processing algorithm and machine learning model includes the following steps:

the server receiving an update request sent by the client, the update request comprising a client device model number, the type of service request initiated, and version information of the current data processing algorithm and machine learning model of the client;

matching to the newest versions of the corresponding data processing algorithm and machine learning model according to the client device model number and the type of service request initiated;

determining whether the current data processing algorithm and machine learning model of the client are the newest versions, and outputting a determination result;

when the determination result is affirmative, notifying the client that the current data processing algorithm and machine learning model are the newest versions, with no updated versions for the time being; or

when the determination result is negative, the server distributing the newest versions of the data processing algorithm and machine learning model to the client.

The second model training module 210 is configured to collect and use characteristic data of each client to train a machine learning model, and store a machine learning model obtained by training in the server model library 21. Reference may be made to the above description of the training of the income characteristic model and fraud detection model in the model application module 130; the second model training module 210 and the first model training module 140 have similar principles and functions, but are different insofar as the first model training module 140 trains a model according to local characteristic data of the client, and the model obtained by training is stored in the client's local model library and can only be used by the client, whereas the second model training module 210 trains a model on the basis of characteristic data of a vast number of users, wherein the characteristic data may be sourced from historical data or third party data or may be characteristic data uploaded by the client user, and the model obtained by training will be stored in the model library 21 of the server and distributed to any client connected to the server according to the needs of each client. In simple terms, the first model training module 140 is responsible for training a personalized machine learning model for use by the client to which it belongs, whereas the second model training module 210 is responsible for training a machine learning model having certain versatility for use by multiple clients.

The management and distribution module 220 is configured to set, match and update a data processing algorithm and machine learning model associated with fraud detection and risk assessment, and provide to the client the service of distributing the data processing algorithm and machine learning model. At the server, server management personnel can set and update an algorithm and a model stored in the server's algorithm library 22 and model library 21 by means of the management and distribution module 220, and maintain a distribution strategy (e.g. set an association between a service of some kind and a certain model). The data processing algorithm comprises a natural language processing algorithm and an image identification algorithm; the machine learning model comprises a GBDT model, a deep neural network model and a random forest model. The management and distribution module 220 provides a distribution service to the client, for the client to download corresponding algorithms and models. Similar to the above description of the algorithm and model management module 140 of the client, it should be further explained that client user data collected by different types of client device, e.g. Android devices, iOS devices and PC devices, are not of exactly the same type; thus, the management and distribution module 220 might need to adaptively adjust the algorithm and model, setting different algorithms and models for client devices of different types. Even in the case where client devices are of the same type, e.g. Android devices, different model numbers of different manufacturers have different hardware configurations, and the management and distribution module 220 will distribute corresponding algorithms and models according to the client device model number, in order to make the best possible use of the computing ability of the client device, e.g. the computing ability of the GPU or independent AI chip.

The risk control decision engine module 230 is configured to receive a model output result uploaded by the client, combine this with historical data and third party data associated with the client user, and output a fraud detection and risk assessment result. The historical data comprises historical data of the client user, e.g. historical transaction data, and further comprises historical data of other users associated with the client user. The third party data comprises data acquired from credit reference platforms, e-commerce platforms, social networking platforms, operator platforms, social security service platforms, provident fund service platforms, banks, etc.; the risk control decision engine can combine the various types of data, make a comprehensive decision, and output a result of fraud detection and risk assessment. The model output result uploaded by a particular client might be limited by the amount of data collected by the client being too small, and thus be somewhat one-sided. For example, in the case of fraud detection when an application for an online loan is made, the user might initiate an online loan application via a new client; the risk control decision engine module 230 can simultaneously perform associative analysis of data of multiple associated users according to social communication characteristics and user material of the client user, and thereby detect group fraud behaviour, even if the client user has not displayed obvious fraud characteristics.

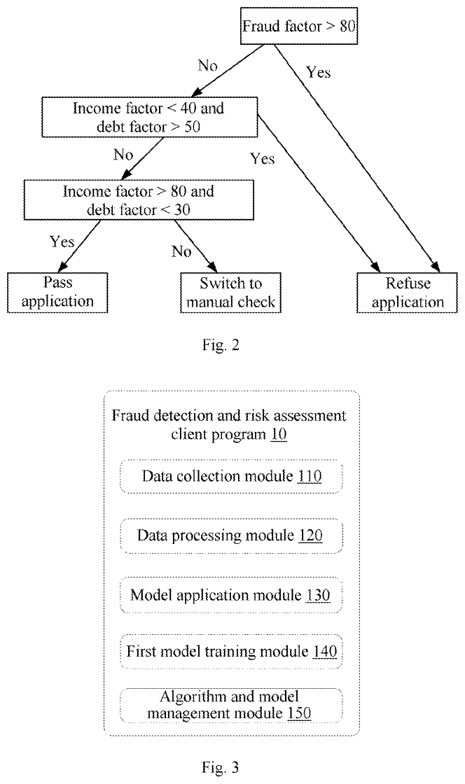

The risk control decision engine module 230 comprises at least one risk control rule, each risk control rule being a decision node of a decision tree; each decision node combines at least one said model output result and associated historical data and third party data, to output at least one risk control factor. The risk control factor comprises a positive risk control factor and a negative risk control factor. When the negative risk control factor is greater than a preset threshold, a decision flows towards a negative evaluation, and when the positive risk control factor is greater than a preset threshold, a decision flows towards a positive evaluation; the risk control decision engine module 230 combines various risk control factors, and outputs a final result of fraud detection and risk assessment. Server management personnel can amend the preset threshold of each risk control factor by means of the risk control decision engine module 230, and can also add and delete decision nodes, thereby influencing the decision flow direction. Referring to FIG. 2, this is an embodiment of the risk control decision engine module 230 in FIG. 1; this embodiment shows a decision process for an “online loan application” in the form of a decision tree. To simplify explanation, suppose that when checking the online loan application, only the fraud probability, debt repayment ability and income situation are taken into account. After receiving the model output result of a fraud detection model, debt repayment ability characteristic model and income characteristic model uploaded by the client which has initiated the online loan application, the risk control decision engine module 230 combines this with historical data and third party data associated with the client user (e.g. debt repayment ability characteristic data and income characteristic data of the user and family members thereof), to obtain three parameters, specifically a fraud factor, an income factor and a debt repayment ability factor, standardizes the value ranges thereof to 0-100, and inputs them to the abovementioned decision tree, to obtain a fraud detection and risk assessment result, finally deciding whether to pass the online loan application or transfer it to manual checking.

The service management module 240 is configured to activate the fraud detection and risk assessment system in response to a service request of the client. Service requests which can activate the fraud detection and risk assessment system include but are not limited to many internet financial services such as online loan applications, payment applications, financial management applications and the purchase of financial insurance.

Referring to FIG. 3, this is a program module diagram of a preferred embodiment of a fraud detection and risk assessment client program 10 stored in a client device (e.g. the client 1 in FIG. 1, not shown in FIG. 3). The client device comprises a memory and a processor, the memory comprising a fraud detection and risk assessment client program 10, the fraud detection and risk assessment client program 10 comprising a data collection module 110, a data processing module 120, a model application module 130, a first model training module 140 and an algorithm and model management module 150. The processor of the client device, when executing the fraud detection and risk assessment client program 10, realizes the abovementioned functions of the program modules 110-150.

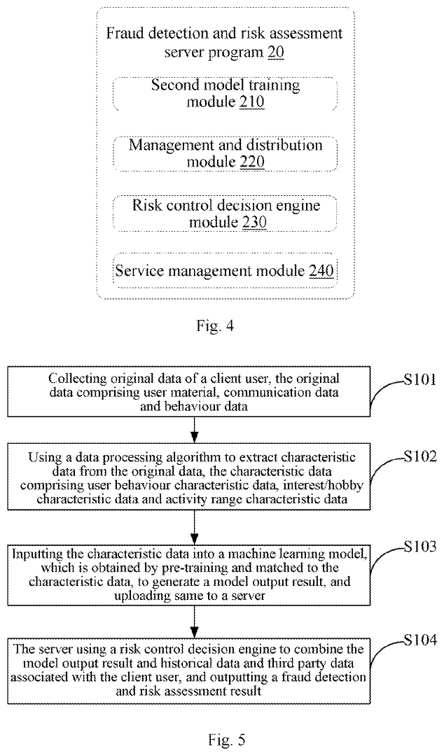

Referring to FIG. 4, this is a program module diagram of a preferred embodiment of a fraud detection and risk assessment server program 20 stored in a server (e.g. the server 2 in FIG. 1, not shown in FIG. 3). The server comprises a memory and a processor, the memory comprising a fraud detection and risk assessment server program 20, the fraud detection and risk assessment server program 20 comprising a second model training module 210, a management and distribution module 220, a risk control decision engine module 230 and a service management module 240. The processor of the server, when executing the fraud detection and risk assessment server program 20, realizes the abovementioned functions of the program modules 210-240.

Referring to FIG. 5, this is a flow chart of a first preferred embodiment of the fraud detection and risk assessment method of the present application. When the fraud detection and risk assessment system is operating, the client performs the following steps:

Step S101: the data collection module 110 collects original data of a client user, including user material, communication data and behaviour data. The original data collected by the data collection module 110 is only for use by the client to which it belongs, and is not uploaded to the server, thereby reducing data transmission costs and the risk of leakage of user private data and secure information.

Step S102: the data processing module 120 uses a data processing algorithm to extract characteristic data of the client user from the original data, including user behaviour characteristic data, interest/hobby characteristic data and activity range characteristic data. The data processing algorithm includes algorithms such as natural language processing algorithms, image identification algorithms and naïve Bayes classification algorithms. These algorithms are generally set at the server by server management personnel, then the server distributes matching algorithms to the client according to the device model number of the client and the data type of the original data to be processed.

Step S103: the model application module 130 inputs the characteristic data into a machine learning model, which is obtained by pre-training and matched to the type of the characteristic data, to generate a model output result, and uploads same to the server. The machine learning model includes natural language processing models, image identification models, fraud detection models, income characteristic models, social interaction characteristic models, payment ability characteristic models, debt repayment ability characteristic models, compliance tendency characteristic models and online shopping characteristic models. The model structure of the machine learning model is generally set at the server by server management personnel; the server distributes a preset machine learning model, or a machine learning model obtained by training at the server, to the client according to the device model number of the client, the type of characteristic data to be processed and the type of service request initiated. After receiving the preset machine learning model, the client will use local characteristic data of the client to subject same to training, to obtain a trained machine learning model. The model application module 130 inputs the characteristic data newly generated by the client into the corresponding trained machine learning model, to generate the model output result, and uploads the generated model output result to the server.

Step S104: the client receives a fraud detection and risk assessment result fed back by the server, said result being output by the risk control decision engine module 230 according to the model output result and historical data and third party data associated with the client user. For the principles and process of the outputting of the fraud detection and risk assessment result by the risk control decision engine module 230, refer to the above description of the risk control decision engine module 230 and the illustration of the online loan application decision tree diagram for the risk control decision engine module in FIG. 2.

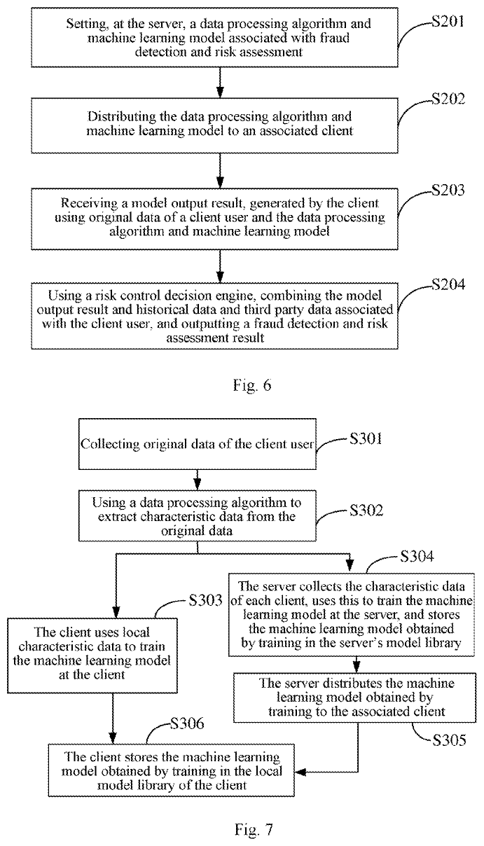

Referring to FIG. 6, this is a flow chart of a second preferred embodiment of the fraud detection and risk assessment method of the present application. When the fraud detection and risk assessment system is operating, the server performs the following steps:

step S201: the management and distribution module 220 is used to set, at the server, a data processing algorithm and machine learning model associated with fraud detection and risk assessment;

step S202: the management and distribution module 220 is used to distribute the data processing algorithm and machine learning model to a client connected to the server; step S203: the server receives the model output result that is generated by the client using the original data of the client user and the data processing algorithm and machine learning model;

step S204: the risk control decision engine module 230 outputs a fraud detection and risk assessment result according to the model output result and historical data and third party data associated with the client user.

Most of the details of implementation of steps S201-S204 have been mentioned above; here, a further explanation will merely be given of the process of training the associated machine learning model and the process of updating the data processing algorithm and machine learning model. The relevant parts of step S101-S104 are also applicable to the following explanation.

Referring to FIG. 7, this is a flow chart of a preferred embodiment of the process of training the machine learning model of the present application. In this embodiment, the process of training the machine learning model comprises the following steps:

Step S301: the data collection module 110 of each client collects original data of the client user.

Step S302: the data processing module 120 of each client uses a data processing algorithm to subject the original data to preliminary processing, in order to extract characteristic data of each client user. If the machine learning model is trained at the client, then step S303 is performed; if the machine learning model is trained at the server, then steps S304-S305 are performed.

Step S303: the client uses local characteristic data to train the machine learning model at the client.

Step S304: the server collects the characteristic data of each client, uses this to train the machine learning model at the server, and stores the machine learning model obtained by training in the server's model library 21.

Step S305: the server distributes the machine learning model obtained by training to the associated client.

Step S306: the client stores the machine learning model obtained by training in the model library 11 of the client.

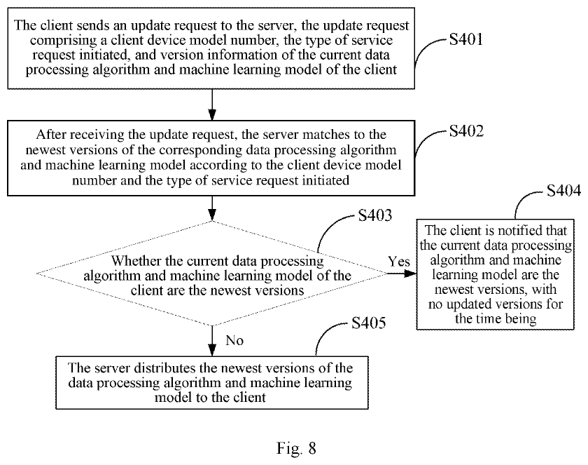

Referring to FIG. 8, this is a flow chart of a preferred embodiment of the process of updating the data processing algorithm and machine learning model of the present application. In this embodiment, the process of matching and updating the data processing algorithm and machine learning model comprises the following steps:

Step S401: the client sends an update request to the server, the update request comprising a client device model number, the type of service request initiated, and version information of the current data processing algorithm and machine learning model of the client.

Step S402: after receiving the update request, the server matches to the newest versions of the corresponding data processing algorithm and machine learning model according to the client device model number and the type of service request initiated.

Step S403: the management and distribution module 220 determines whether the current data processing algorithm and machine learning model of the client are the newest versions, and outputs a determination result. When the determination result is “yes”, step S404 is performed; when the determination result is “no”, step S405 is performed.

Step S404: the client is notified that the current data processing algorithm and machine learning model are the newest versions, with no updated versions for the time being.

Step S405: the server distributes the newest versions of the data processing algorithm and machine learning model to the client.

In addition, the embodiments of the present application further propose a computer-readable storage medium, which may be any one of, or any combination of more than one of, a hard disk, multimedia card, SD card, flash card, SMC, read-only memory (ROM), erasable programmable read-only memory (EPROM), portable compact disk read-only memory (CD-ROM) and USB memory, etc. The computer-readable storage medium comprises the fraud detection and risk assessment client program 10; when executed, the fraud detection and risk assessment client program 10 realizes the following steps:

a data collection step: collecting original data of a client user, the original data comprising user material, communication data and behaviour data;

a data processing step: using a data processing algorithm to extract characteristic data from the original data, the characteristic data comprising user behaviour characteristic data, interest/hobby characteristic data and activity range characteristic data;

a model application step: inputting the characteristic data into a machine learning model, which is obtained by pre-training and matched to the characteristic data, to generate a model output result, and uploading same to a server; and

a receiving step: receiving a fraud detection and risk assessment result fed back by the server, said result being output by a risk control decision engine according to the model output result and historical data and third party data associated with the client user.

The embodiments of the present application further propose another computer-readable storage medium, comprising a fraud detection and risk assessment server program 20; when executed, the fraud detection and risk assessment server program 20 realizes the following steps:

a setting step: setting a data processing algorithm and machine learning model associated with fraud detection and risk assessment;

a distributing step: distributing the data processing algorithm and machine learning model to an associated client;

a receiving step: receiving a model output result, generated by the client using original data of a client user and the data processing algorithm and machine learning model;

an output step: using a risk control decision engine, combining the model output result and historical data and third party data associated with the client user, and outputting a fraud detection and risk assessment result. Particular embodiments of the computer-readable storage medium of the present application are substantially the same as particular embodiments of the abovementioned fraud detection and risk assessment method and system, so are not described further here.

It should be explained that in the present text, the term “comprises”, “includes” or any other variant thereof is intended to encompass non-exclusive inclusion, such that a process, apparatus, object or method comprising a series of key elements does not only comprise these elements, but also comprises other key elements which are not set out explicitly, or also comprises key elements intrinsic to such a process, apparatus, object or method. Further, technical solutions of different embodiments may be combined with each other, but this must be based on implementability by those skilled in the art; where a combination of technical solutions gives rise to contradiction or cannot be implemented, such a combination of technical solutions should be regarded as being non-existent, and outside the scope of protection claimed in the present application.

Through the above description of embodiments, those skilled in the art can clearly learn that the methods of the embodiments above can be implemented by means of software together with a necessary general-purpose hardware platform, or of course by means of hardware, but the former is a better mode of implementation in many cases. Based on such understanding, the essence of the technical solution of the present application, i.e. the part thereof which makes a contribution to the prior art, may be embodied in the form of a software product; the computer software product is stored in a storage medium as described above, and includes a number of instructions for causing a server to execute the method described in the various embodiments of the present application.

The above are merely preferred embodiments of the present application, and do not thereby limit the patent scope thereof. All equivalent structural or equivalent flow transformations made using the content of the description and drawings of the present application, or direct or indirect applications in other related technical fields, are by the same principle included in the scope of patent protection of the present application.

1. A fraud detection and risk assessment method, applied to a client, characterized in that the method comprises:
a data collection step: collecting original data of a client user, the original data comprising user material, communication data and behaviour data;
a data processing step: using a data processing algorithm to extract characteristic data from the original data, the characteristic data comprising user behaviour characteristic data, interest/hobby characteristic data and activity range characteristic data;
a model application step: inputting the characteristic data into a machine learning model, which is obtained by pre-training and matched to the characteristic data, to generate a model output result, and uploading same to a server; and
a receiving step: receiving a fraud detection and risk assessment result fed back by the server, said result being output by a risk control decision engine according to the model output result and historical data and third party data associated with the client user.

2. A fraud detection and risk assessment method, applied to a server, characterized in that the method comprises:
a setting step: setting a data processing algorithm and machine learning model associated with fraud detection and risk assessment;
a distributing step: distributing the data processing algorithm and machine learning model to an associated client;
a receiving step: receiving a model output result, generated by the client using original data of a client user and the data processing algorithm and machine learning model;
an output step: using a risk control decision engine, combining the model output result and historical data and third party data associated with the client user, and outputting a fraud detection and risk assessment result.

3. The fraud detection and risk assessment method as claimed in claim 1, characterized in that the risk control decision engine comprises at least one risk control rule, each risk control rule being a decision node of a decision tree, each decision node combining at least one said model output result and associated historical data and third party data, and outputting at least one risk control factor, and the risk control decision engine combines the risk control factors and outputs the fraud detection and risk assessment result.

4. The fraud detection and risk assessment method as claimed in claim 1, characterized in that a process of training the machine learning model comprises the following steps:
collecting original data of the client user;
using a data processing algorithm to extract characteristic data from the original data;
using the characteristic data to train the machine learning model locally at the client;
storing the machine learning model obtained by training in a local model library of the client.

5. The fraud detection and risk assessment method as claimed in claim 4, characterized in that the process of training the machine learning model may be replaced with:
the server distributing a data processing algorithm to the associated client;
each client using the data processing algorithm to extract characteristic data from original data of the client user, and uploading same to the server;
the server using the characteristic data of each client user to train the machine learning model, and storing the machine learning model obtained by training in a model library of the server;
the server distributing the machine learning model obtained by training to the associated client.

6. The fraud detection and risk assessment method as claimed in claim 1, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

7. A fraud detection and risk assessment system, characterized in that the system comprises:
a server, and
at least one client;
the client comprising:
a data collection module, configured to collect original data of a client user, the original data comprising user material, communication data and behaviour data;
a data processing module, configured to use a data processing algorithm to extract characteristic data from the original data, the characteristic data comprising user behaviour characteristic data, interest/hobby characteristic data and activity range characteristic data;
a model application module, configured to input the characteristic data into a machine learning model, which is obtained by pre-training and matched to a type of the characteristic data, to generate a model output result, and upload same to a server;
a first model training module, configured to use local characteristic data of the client to train the machine learning model at the client, and store the machine learning model obtained by training in a local model library of the client;
an algorithm and model management module, configured to match and update the data processing algorithm and machine learning model;
the server comprising:
a second model training module, configured to collect and use characteristic data of each client, to train the machine learning model, and store the machine learning model obtained by training in a model library of the server;
a management and distribution module, configured to set, match and update the data processing algorithm and machine learning model associated with fraud detection and risk assessment, and provide to the client the service of distributing the data processing algorithm and machine learning model;
a risk control decision engine module, configured to receive the model output result uploaded by the client, combine this with historical data and third party data associated with the client user, and output a fraud detection and risk assessment result;
a service management module, configured to activate the fraud detection and risk assessment system in response to a service request of the client.

8. A client device, characterized in that the client device stores a fraud detection and risk assessment client program, and the client device, when executing the fraud detection and risk assessment client program, realizes the following steps:
a data collection step: collecting original data of a client user, the original data comprising user material, communication data and behaviour data;
a data processing step: using a data processing algorithm to extract characteristic data from the original data, the characteristic data comprising user behaviour characteristic data, interest/hobby characteristic data and activity range characteristic data;
a model application step: inputting the characteristic data into a machine learning model, which is obtained by pre-training and matched to the characteristic data, to generate a model output result, and uploading same to a server; and
a receiving step: receiving a fraud detection and risk assessment result fed back by the server, said result being output by a risk control decision engine according to the model output result and historical data and third party data associated with the client user.

9. The client device as claimed in claim 8, characterized in that a process of training the machine learning model comprises the following steps:
collecting original data of the client user;
using a data processing algorithm to extract characteristic data from the original data;
using the characteristic data to train the machine learning model locally at the client;
storing the machine learning model obtained by training in a local model library of the client.

10. The client device as claimed in claim 8, characterized in that a process of updating the data processing algorithm and machine learning model comprises the following steps:
sending an update request for the data processing algorithm and machine learning model to the server, the update request comprising a client device model number, a type of service request initiated, and version information of the current data processing algorithm and machine learning model of the client;
receiving version information of the newest versions of the data processing algorithm and machine learning model matched to by the server according to the client device model number and the type of service request initiated;
determining whether the current data processing algorithm and machine learning model are the newest versions, and outputting a determination result;
when the determination result is affirmative, displaying that the current data processing algorithm and machine learning model are the newest versions, with no updated versions for the time being; or
when the determination result is negative, receiving the newest versions of the data processing algorithm and machine learning model distributed by the server.

11. A server, characterized in that the server stores a fraud detection and risk assessment server program, and the server, when executing the fraud detection and risk assessment server program, realizes the following steps:
a setting step: setting a data processing algorithm and machine learning model associated with fraud detection and risk assessment;
a distributing step: distributing the data processing algorithm and machine learning model to an associated client;
a receiving step: receiving a model output result, generated by the client using original data of a client user and the data processing algorithm and machine learning model;
an output step: using a risk control decision engine, combining the model output result and historical data and third party data associated with the client user, and outputting a fraud detection and risk assessment result.

12. The server as claimed in claim 11, characterized in that the risk control decision engine comprises at least one risk control rule, each risk control rule being a decision node of a decision tree, each decision node combining at least one said model output result and associated historical data and third party data, and outputting at least one risk control factor, and the risk control decision engine combines the risk control factors and outputs the fraud detection and risk assessment result.

13. The server as claimed in claim 11, characterized in that a process of training the machine learning model comprises the following steps:
distributing a data processing algorithm to the associated client;
receiving characteristic data extracted from original data of the client user by each client using the data processing algorithm;
using the characteristic data of each client user to train the machine learning model, and storing the machine learning model obtained by training in a model library of the server;
distributing the machine learning model obtained by training to the associated client.

14. The server as claimed in claim 11, characterized in that a process of updating the data processing algorithm and machine learning model comprises the following steps:
receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

15. A computer-readable storage medium, characterized in that the computer-readable storage medium comprises a fraud detection and risk assessment client program which, when executed, realizes the following steps:
a data collection step: collecting original data of a client user, the original data comprising user material, communication data and behaviour data;
a data processing step: using a data processing algorithm to extract characteristic data from the original data, the characteristic data comprising user behaviour characteristic data, interest/hobby characteristic data and activity range characteristic data;
a model application step: inputting the characteristic data into a machine learning model, which is obtained by pre-training and matched to the characteristic data, to generate a model output result, and uploading same to a server; and
a receiving step: receiving a fraud detection and risk assessment result fed back by the server, said result being output by a risk control decision engine module according to the model output result and historical data and third party data associated with the client user.

16. The computer-readable storage medium as claimed in claim 15, characterized in that a process of training the machine learning model comprises the following steps:
collecting original data of the client user;
using a data processing algorithm to extract characteristic data from the original data;
using the characteristic data to train the machine learning model locally at the client;
storing the machine learning model obtained by training in a local model library of the client.

17. The computer-readable storage medium as claimed in claim 15, characterized in that a process of updating the data processing algorithm and machine learning model comprises the following steps:
sending an update request for the data processing algorithm and machine learning model to the server, the update request comprising a client device model number, a type of service request initiated, and version information of the current data processing algorithm and machine learning model of the client;
receiving version information of the newest versions of the data processing algorithm and machine learning model matched to by the server according to the client device model number and the type of service request initiated;
determining whether the current data processing algorithm and machine learning model are the newest versions, and outputting a determination result;
when the determination result is affirmative, displaying that the current data processing algorithm and machine learning model are the newest versions, with no updated versions for the time being; or
when the determination result is negative, receiving the newest versions of the data processing algorithm and machine learning model distributed by the server.

18. A computer-readable storage medium, characterized in that the computer-readable storage medium comprises a fraud detection and risk assessment server program which, when executed, realizes the following steps:
a setting step: setting a data processing algorithm and machine learning model associated with fraud detection and risk assessment;
a distributing step: distributing the data processing algorithm and machine learning model to an associated client;
a receiving step: receiving a model output result, generated by the client using original data of a client user and the data processing algorithm and machine learning model;
an output step: using a risk control decision engine module, combining the model output result and historical data and third party data associated with the client user, and outputting a fraud detection and risk assessment result.

19. The computer-readable storage medium as claimed in claim 18, characterized in that a process of training the machine learning model comprises the following steps:
distributing a data processing algorithm to the associated client;
receiving characteristic data extracted from original data of the client user by each client using the data processing algorithm;
using the characteristic data of each client user to train the machine learning model, and storing the machine learning model obtained by training in a model library of the server;
distributing the machine learning model obtained by training to the associated client.

20. The computer-readable storage medium as claimed in claim 18, characterized in that a process of updating the data processing algorithm and machine learning model comprises the following steps:
receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

21. The fraud detection and risk assessment method as claimed in claim 2, characterized in that the risk control decision engine comprises at least one risk control rule, each risk control rule being a decision node of a decision tree, each decision node combining at least one said model output result and associated historical data and third party data, and outputting at least one risk control factor, and the risk control decision engine combines the risk control factors and outputs the fraud detection and risk assessment result.

22. The fraud detection and risk assessment method as claimed in claim 2, characterized in that a process of training the machine learning model comprises the following steps:
collecting original data of the client user;
using a data processing algorithm to extract characteristic data from the original data;
using the characteristic data to train the machine learning model locally at the client;
storing the machine learning model obtained by training in a local model library of the client.

23. The fraud detection and risk assessment method as claimed in claim 22, characterized in that the process of training the machine learning model may be replaced with:
the server distributing a data processing algorithm to the associated client;
each client using the data processing algorithm to extract characteristic data from original data of the client user, and uploading same to the server;
the server using the characteristic data of each client user to train the machine learning model, and storing the machine learning model obtained by training in a model library of the server;
the server distributing the machine learning model obtained by training to the associated client.

24. The fraud detection and risk assessment method as claimed in claim 2, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

25. The fraud detection and risk assessment method as claimed in claim 3, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

26. The fraud detection and risk assessment method as claimed in claim 21, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

27. The fraud detection and risk assessment method as claimed in claim 4, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

28. The fraud detection and risk assessment method as claimed in claim 22, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

29. The fraud detection and risk assessment method as claimed in claim 5, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

30. The fraud detection and risk assessment method as claimed in claim 23, characterized in that a process of updating the data processing algorithm and machine learning model comprises the following steps:
the server receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

31. The client device as claimed in claim 9, characterized in that a process of updating the data processing algorithm and machine learning model comprises the following steps:
sending an update request for the data processing algorithm and machine learning model to the server, the update request comprising a client device model number, a type of service request initiated, and version information of the current data processing algorithm and machine learning model of the client;
receiving version information of the newest versions of the data processing algorithm and machine learning model matched to by the server according to the client device model number and the type of service request initiated;
determining whether the current data processing algorithm and machine learning model are the newest versions, and outputting a determination result;
when the determination result is affirmative, displaying that the current data processing algorithm and machine learning model are the newest versions, with no updated versions for the time being; or
when the determination result is negative, receiving the newest versions of the data processing algorithm and machine learning model distributed by the server.

32. The server as claimed in claim 12, characterized in that a process of updating the data processing algorithm and machine learning model comprises the following steps:
receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

33. The server as claimed in claim 13, characterized in that a process of updating the data processing algorithm and machine learning model comprises the following steps:
receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.

34. The computer-readable storage medium as claimed in claim 16, characterized in that a process of updating the data processing algorithm and machine learning model comprises the following steps:
sending an update request for the data processing algorithm and machine learning model to the server, the update request comprising a client device model number, a type of service request initiated, and version information of the current data processing algorithm and machine learning model of the client;
receiving version information of the newest versions of the data processing algorithm and machine learning model matched to by the server according to the client device model number and the type of service request initiated;
determining whether the current data processing algorithm and machine learning model are the newest versions, and outputting a determination result;
when the determination result is affirmative, displaying that the current data processing algorithm and machine learning model are the newest versions, with no updated versions for the time being; or
when the determination result is negative, receiving the newest versions of the data processing algorithm and machine learning model distributed by the server.

35. The computer-readable storage medium as claimed in claim 19, characterized in that a process of updating the data processing algorithm and machine learning model comprises the following steps:
receiving an update request sent by the client, the update request comprising a client device model number, a type of service request initiated, and version information of the current data processing algorithm and machine learning model of the client;
matching to the newest versions of the corresponding data processing algorithm and machine learning model according to the client device model number and the type of service request initiated;
determining whether the current data processing algorithm and machine learning model of the client are the newest versions, and outputting a determination result;
when the determination result is affirmative, notifying the client that the current data processing algorithm and machine learning model are the newest versions, with no updated versions for the time being; or
when the determination result is negative, the server distributing the newest versions of the data processing algorithm and machine learning model to the client.
